(19) United States
(12) Patent Application Publication
(10) Pub. No.: US 2001/0019790 A1
(43) Pub. Date: Sep. 6, 2001

(54) Fuel Cell Gasket Assembly and Method of Assembling Fuel Cells

(75) Inventors: Mr. Mark J. Regan, Grand Rapids, Michigan (US); Mr. Ralph L. Gooch, Plainwell, Michigan (US)

Correspondence Address: Mark A. Davis, Esq., Joel E. Bair, Esq., 171 Monroe Avenue, N.W., Suite 600, Grand Rapids, Michigan, 49503, US, mad@raderfishman.com, (616) 742-3500, (616) 742-1010

(73) Assignee: Flexfab Horizons International, Inc., Hastings, 49058 (US)

(21) Appl. No.: 09/716,689

(22) Filed: Nov. 20, 2000

Related U.S. Application Data
(63) Continuation of application No. PCT/US00/04050, filed on Feb. 16, 2000.
(60) Provisional application No. 60/123,552, filed on Mar. 10, 1999.

(51) Int. Cl. H01M 8/02; H01M 2/08

(52) U.S. Cl. 429/35; 429/36; 29/623.2

(57) ABSTRACT

### Abstract of Disclosure

The invention is an improved fuel cell sealing system comprising a proton exchange membrane sandwiched between an anode plate and a cathode plate. A gasket is provided to seal the proton exchange membrane with the anode and cathode plates. The gasket has a multi-lobe cross section, with each lobe defining a seal line between the gasket and the adjacent plate.

### Cross Reference to Related Applications

This application claims under 35 U.S.C. 120 the benefit of the filing date of International Application PCT/US00/04050, filed February 16, 2000, which claims priority under 35 U.S.C. § 119 on United States provisional patent application number 60/123,552 filed March 10, 1999.

### Background of Invention

Field of the InventionThe invention relates to proton exchange membrane (PEM) fuel cells, and more particularly, to an improved PEM fuel cell gasket. In another aspect, the invention relates to an improved gasket design.

Description of the Related ArtPEM fuel cells are well known for using hydrogen and air to generate electrical energy through a catalytic process with only water and heat as byproducts. Fuel cells have been recognized as a potential solution to extracting power from hydrocarbon-based fuels without the deleterious emissions associated with more traditional combustion systems.

A fuel cell generally comprises opposing plates between which is disposed a proton permeable membrane. One of the plates forms the anode and the other forms the cathode of an electrical circuit for the fuel cell. A gasket is disposed between each plate in the cell to seal the plates with respect to the membrane. The internal pressures of the fuel cell can be relatively high and gas is corrosive to many materials. The gasket/plate interface must resist the fuel cell internal pressure and have a relatively high resistance to corrosion. Any failure of the gasket resulting in a leaking of the hydrogen or air is highly undesirable.

Each planar surface of each plate has multiple grooves formed therein to provide flow paths for the fuel (anode plate) and air (cathode plate). A gas diffusion fabric layer (GDL) is placed between each plate and the membrane.

In operation, the fuel is reformed in such a manner so that substantially only hydrogen gas and air enters the channels of the anode plate where the hydrogen gas and air react with the coated PEM to separate the protons and the electrons. The protons pass through the membrane and the electrons are carried away through the anode to form an electric current. Air is directed into the channels of the cathode plate and reacts with the protons passing through the membrane to form water and heat as byproducts. In this manner, the fuel is converted into electrical energy through a catalytic reaction that produces only water and heat as byproducts and results in only trace amounts of noxious emissions or byproducts, unlike internal combustion devices.

A fuel cell is inherently limited in the amount of voltage that it can produce. To increase voltage, it is known to stack multiple fuel cells in a structure commonly called a fuel cell stack. A disadvantage of a fuel cell stack is that sometimes hundreds of fuel cells must be stacked on top of each other to achieve a desired electrical output and they require good sealing to prevent the escape of hydrogen gas. Gaskets are placed on each side of the PEM and the corresponding anode or cathode plate to keep the hydrogen and air from leaking.

Compression rods extend through the fuel cells to apply a compressive force to fuel cell stack. The compressive force performs multiple functions. One function is to hold together the multiple fuel cells as an integral unit. Another function is to press the anode or cathode plate against the GDL with sufficient force to maintain contact therebetween; otherwise, the hydrogen or air can escape the channels in the plates, preventing the desired distribution of hydrogen or air across the face of the GDL and reducing the performance of the fuel cell.

A fuel cell stack is susceptible to various forms of pressure that can cause leakage and which the internal gasket must prevent. For example, the fuel cell stack is subjected to the weight of the many stacked fuel cells, each of which adds to the pressure acting on each gasket. The pressure applied by the fuel cell weight is minor in comparison to the compressive force applied by the compression rods, which pressure is approximately 25 psig. The gasket must also resist the internal pressure of the hydrogen or gas, which is approximately 30 psig.

The stacking process is manually intensive and exacerbated by the relative thinness of each of the components. For example, it is common for the membrane to be approximately .0015 inches or less in thickness. There is also inherently an increased chance of misalignment of the gasket as more fuel cells are stacked. The manual handling of the membrane, the GDL, the gaskets, and the plates greatly slows the assembly time and increases the likelihood of an error during assembly. It is highly desirable to obtain a fuel cell structure that would simplify the stacking process and permit the automation of the stacking process. It is also desirable for the fuel cell stack to resist leakage.

### Summary of Invention

The invention relates to a fuel cell assembly comprising a first fuel cell plate and a second fuel cell plate, with a gasket adapted to form a seal between the first and second fuel cell plates. The gasket includes at least two spaced lobes to contact the first fuel cell plate when the gasket is compressed between the first and second fuel cell plates.

Preferably, one of the at least two spaced lobes contacts the first fuel cell plate when the gasket is uncompressed and another one of the at least two spaced lobes does not contact the first fuel cell plate when the gasket is uncompressed.

A gasket groove can be formed in one of the first and second plates and the gasket at least partially resides within the gasket groove.

The gasket can further include channels between said at least two spaced lobes and which are substantially parallel to the at least two spaced lobes. The channels can have a generally curved cross-section, and are preferably arcuate in cross-section. The radius of curvature of the arcuate cross-section is approximately between 0.020 inches and 0.025 inches. At least one of the lobes can have a radius of curvature of approximately between 0.005 and 0.010.

A protuberance can extend from the sides of the gasket. The protuberance is adapted to expand between the first and second plates when compressed. The protuberance can have a radius of curvature of approximately between 0.02 and 0.04.

In another aspect of the invention, the gasket can have at least three spaced lobes to contact the first fuel cell plate when the gasket is compressed between the first and second fuel cell plates. In the three spaced lobe configuration, it is preferred that at least two of the three spaced lobes contact the first fuel cell plate when the gasket is uncompressed and another one of the at least three spaced lobes does not contact the first fuel cell plate when the gasket is uncompressed. Preferably, the non-contacting lobe in the uncompressed state is located between the at least two lobes contacting the first fuel cell plate in the uncompressed state.

The invention also relates to a method of assembling a first and second fuel cell plate. The method includes forming a seal between the first and second fuel cell plates used in a gasket, and compressing the gasket between the first and second fuel cell plates to cause the at least three spaced lobes of the gasket to contact the first fuel cell plate.

The method can further include contacting the first fuel cell plate with two of said at least three spaced lobes and preventing another one of said at least three lobes from contacting the first fuel cell plates before the compressing of the gasket.

### Brief Description of Drawings

In the drawings:FIG. 1 is a perspective view of a fuel stack comprising multiple fuel cells according to the invention;

FIG. 2 is an exploded view of a fuel cell of FIG. 1 illustrating the fuel cell components of a membrane/gasket assembly and GDL material positioned between two opposing plates;

FIG. 3 is a sectional view taken along line 4-4 of the cell stack of FIG. 1;

FIG. 4 is a perspective view of an assembly line for automatically molding the membrane/gasket assembly and nesting for shipment;

FIG. 5 is a perspective view of an alternative construction for the membrane/gasket assembly;

FIG. 6 is an exploded view of a second embodiment of a fuel cell illustrating the fuel cell components of a membrane/gasket assembly and GDL material positioned between two opposing plates;

FIG. 7 is an enlarged sectional view illustrating the unassembled relationship between the plates, membrane, gasket, and GDL of the second embodiment;

FIG. 8 is similar to FIG. 7 except the fuel cell is assembled;

FIG. 9 is a sectional view similar to FIG. 8 without the GDL layer extending beneath the gasket;

FIG. 10 is a sectional view similar to FIG. 9 without the membrane extending beneath the gasket;

FIG. 11 is a perspective view of an alternative gasket design for the second embodiment of FIG. 6;

FIG. 12 is a sectional view taken along line 12-12 of FIG. 11;

FIG. 13 is an enlarged sectional view illustrating the unassembled relationship between the plates, membrane, gasket, and GDL of an alternative gasket construction; and

FIG. 14 is similar to FIG. 13 except the fuel cell is assembled.

### Detailed Description

FIG. 1 illustrates a fuel stack 10 comprising multiple fuel cells 12 compressibly retained between opposing end plates 14. The fuel cell stack 10 receives hydrogen fuel and converts it to electrical power by a catalytic process. The operation of the fuel cell stack is commonly known and will not be described in further detail.

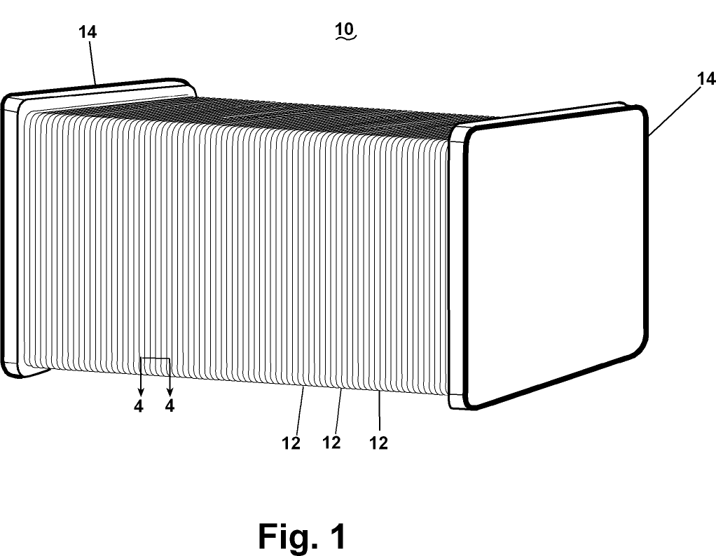

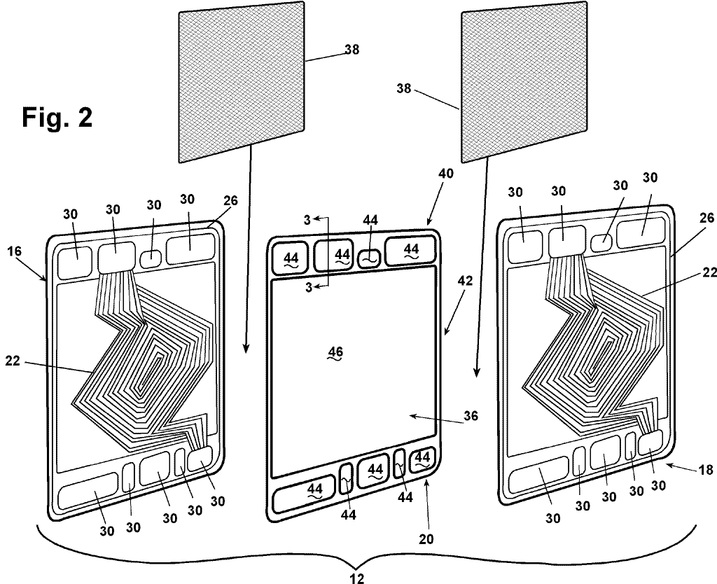

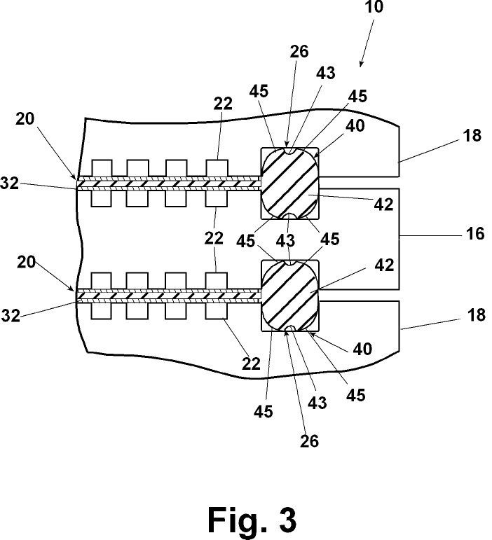

FIGS. 2 and 3 illustrate the basic components of one of the fuel cells 12 that comprise the fuel stack 10. The fuel cell 12 comprises opposing plates 16, 18 between which is disposed a pair of gas diffusion layers (GDL) 38, and between which is disposed a membrane/gasket assembly 20, according to the invention.

Each plate 16, 18 has opposing surfaces on which are formed a series of grooves 22. These grooves are well known and define a flow path for either the fuel or air across the plates during the catalytic process. Each plate also has a gasket groove 26.

At least a portion of the plates 16, 18 form the anode or cathode of an electrical circuit for the fuel cell. The plate that forms the anode is connected to the source of fuel and receives hydrogen gas within the grooves. The plate that forms the cathode is connected to a source of air that is directed through its grooves. The plates have multiple openings 30. The openings can be for many different purposes, including passageways for structural elements of the fuel cell stack, fuel, air, or electrical conduit to name a few.

The membrane/gasket assembly 20 comprises a proton exchange membrane (PEM) 36 attached to a gasket 40. The PEM 36 can be made from Nafion®, manufactured by DuPont, which is a Teflon product having an acidic base. Nafion® is limited to lower temperature assembly methods as it is currently susceptible to damage is heated to 200 °F for too long. New PEM materials having a phosphoric base can withstand temperatures up to 400 °F. The particular PEM used is not of importance to the invention other than the PEM have characteristics suitable for the particular assembly method and anticipated operating environment. The beads 42 are preferably formed with opposing channels 43 that define spaced lobes 45 that abut the closed end of the channel 26 to form separate seal lines relative thereto.

The membrane/gasket assembly 20 comprises a gasket 40 having sealing beads 42. The gasket 40 defines multiple openings 44 that correspond to openings 30 in the plates 16, 18.

The gasket 40 also defines a membrane working area 46, which substantially overlies the grooves 22 when the fuel cell is assembled to enhance the transfer of protons. The gasket material must be substantially impermeable to hydrogen. Although it need not be absolutely impermeable, the gasket need be sufficiently permeable to retain an internal pressure of 1-30 psig inside the fuel stack. A preferred gasket material is an elastomeric product such as silicone rubber or any other suitable elastomeric product. The GDL 38 is sized to cover the working area 46 of the PEM 36. Although the GDL 38 is shown as being separate from the PEM 36, it is within the scope of the invention for the GDL 38 to be bonded to or part of the PEM 36. It is also within the scope of the invention for the catalyst to be applied to the plate surface in addition to or in lieu of the catalyst on the GDL.

FIG. 3 is a portion of a fuel cell stack 10 illustrating the interrelationship between the plates 16, 18 and the membrane/gasket assembly 20. When assembled, the gasket 40 is received within the gasket groove 26 of the opposing plates to seal the plates with respect to the membrane/gasket assembly 20.

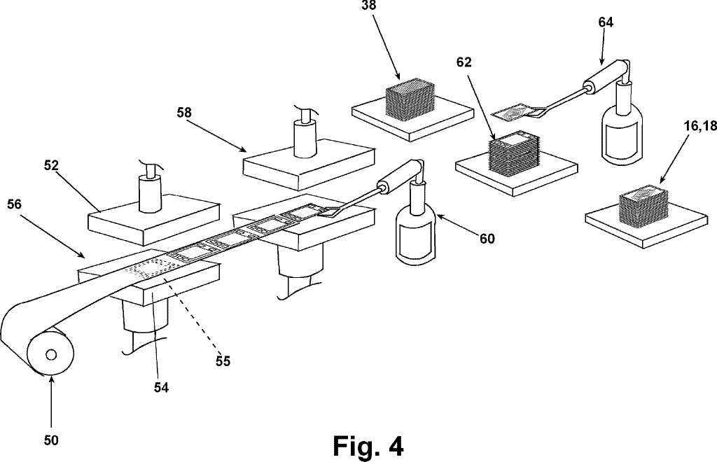

The manufacture and assembly of a fuel cell using a membrane/gasket assembly 20 will be described with reference to FIG. 4, which is a schematic illustration of the assembling apparatus. Initially, a roll 50 of PEM 36 is provided. It is preferred that the PEM 36 not include the GDL 38. However, depending on the assembly method, it is contemplated that the GDL 38 could be integrally formed with the PEM 36. It is also contemplated that the roll 50 be replaced by individual sheets.

The PEM 36 is indexed or placed corresponding to the desired size and positioned between opposing mold halves 52, 54 of a mold 56. The mold halves 52, 54 both have mold cavities 55 that when closed form the shape of the gasket 40.

The PEM 36 is positioned between the mold halves 52, 54 and positioned in registry with respect to the mold cavities 55. It is anticipated that the index of the membrane material will provide a reference point to establish registry between the roll of PEM and the mold halves 52, 54.

Once the PEM 36 is in registry with the mold halves 52, 54, the mold halves are closed and thereby compressibly retain the PEM 36 therebetween. The gasket material, preferably silicone rubber or any other suitable elastomeric material, is then injected into the mold cavities on opposite sides of the membrane material and heated to the curing temperature. The injected silicone or other suitable material is kept at the heated temperature until cured. Alternatively, the gasket material can be injected into one of the cavities 55 and pass through the PEM 36 to fill the other cavity.

Although silicone rubber or flurosilicone are the preferred gasket materials, other suitable materials can be used. It is preferred that the gasket materials cure at a temperature less than a temperature that is deleterious to the PEM 36.

Preferably, the portion of the mold adjacent the membrane working area 46 is cooled to insure that the membrane does not degrade during the molding of the gasket. It is preferred that the portion of the mold adjacent the membrane working area is kept below 200°F. Temperatures above 200°F tend to degrade the beneficial characteristics of a Nafion®PEM. To accomplish this, the mold can be cooled by circulating a coolant, such as water, through the relevant portions of the mold halves.

Once the gasket material has cured, the mold halves are opened and the PEM membrane material is advanced to the next index position, placed in registry with respect to the mold halves and the gasket molding process is repeated.

The output from the mold 56 comprising membrane/gasket assemblies connected by the web of PEM 36 is advanced to a trimming station 58, which is preferably a punch press or similar machine. The trimming station cuts the membrane/gasket assembly 20 from the roll 50 of PEM 36 and simultaneously punches out those portions of the membrane located in the openings 44 if the PEM is not pre-punched. After the trimming process, the membrane/gasket assembly 20 is ready for packaging.

A robotic 60 or a similar device moves the membrane/gasket assembly 20 from the trimming station 58 and mounts it onto a partially assembled fuel cell stack 60. The membrane/gasket assembly 20 is aligned with the plate 18 of the partially assembled fuel cell stack 62 so that the seal is aligned with the corresponding grooves 28 in the surface of the plate 18. A second robotic arm 64 then sequentially positions a GDL sheet 38 and then a plate 16 on top of the just positioned GDL 38 and membrane/gasket assembly 20 so that the gasket seal is received within the seal groove 26 on the surface of the plate 16. This process is repeated until the desired number of fuel cells 12 are formed in the fuel cell stack 62.

In the event the GDL 38 is integral with the PEM 36, then it will not be necessary to place the GDL 38 on the stack 62. Also, although not preferred, the PEM and GDL can be manually loaded into and/or removed from the mold instead of being fed from a roll. The manual process will result in an equally suitable membrane/gasket assembly 20, but will undesirably increase the manually handling during the process. The automation of the fuel cell stack assembly can be made possible by the integral membrane/gasket assembly 20, which, when combined, provides much greater structural integrity than either one alone, especially the membrane. The greater structural integrity greatly increases the ease of handling and positioning of the membrane/gasket assembly 20 over the prior art method of handling each separately. The gasket 40 in combination with the grooves in the plates 10, 18 aid in positioning the membrane/gasket assembly 20. The increased structural integrity and the ease of positioning associated wit the membrane/gasket assembly 20 permits the automation of the assembly of the fuel cell 12.

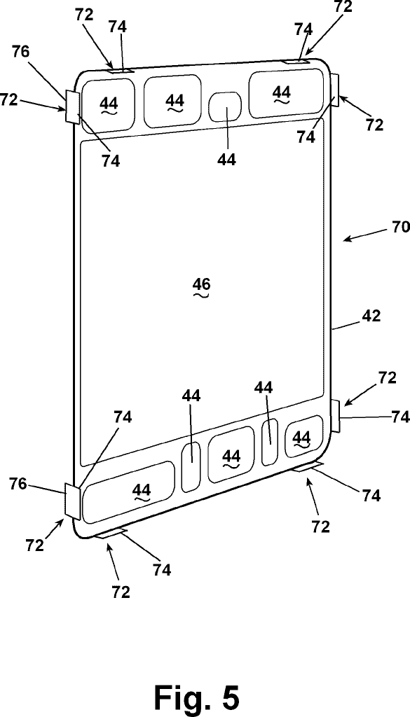

FIG. 5 illustrates an alternative membrane/gasket assembly 70 construction. The membrane/gasket assembly 70 is very similar to the membrane/gasket assembly 20, except that positioning tabs 72 are formed adjacent the corners or as required of the membrane/gasket assembly 70. The positioning tabs 76 preferably include opposing positioning elements 72, 74 that extend outwardly a sufficient distance so that they will not be trapped between the opposing plates 16, 18 during assembly. The positioning tabs 72, 74 are used to position the membrane/gasket assembly 70 with respect to the plates 16, 18 during assembly.

With the membrane/gasket assembly 70, there is less of a need for the plates to have a gasket groove for its positioning function. However, the gasket groove still provides a valuable sealing function.

If the gasket groove is not used, the gasket 70 merely abuts the surface of the plates 16, 18 to form the seal. Typically, the height of the peripheral bead will need to be reduced to the height of the remainder of the gasket.

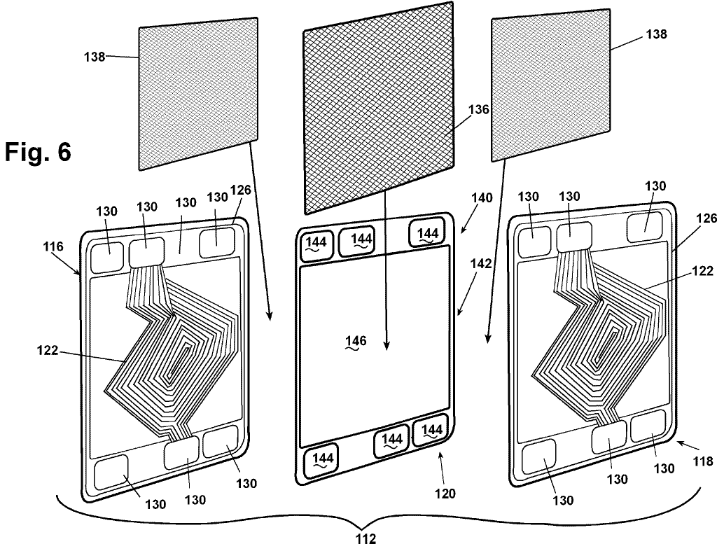

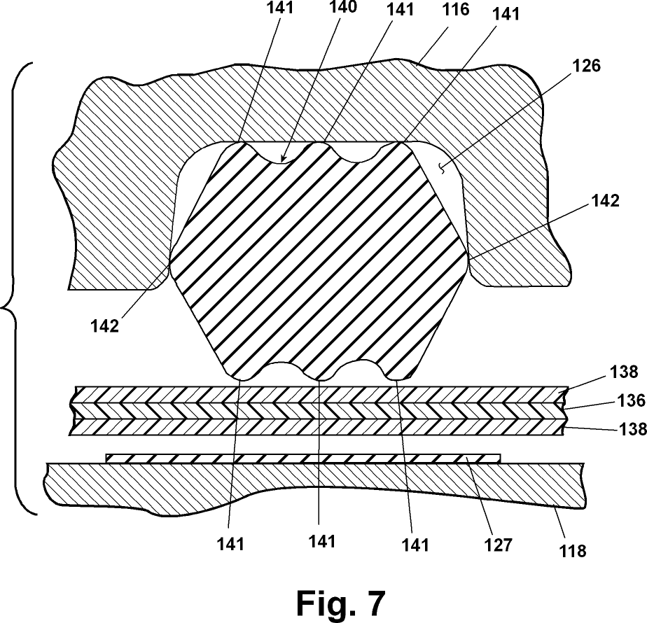

FIGS. 6 and 7 illustrate a second embodiment of a fuel cell 112 according to the invention. The fuel cell 112 comprises a pair of electrically conductive plates 116 and 118 between which is disposed a membrane/gasket assembly 120. A series of grooves 122 are provided on each face of the plates 116, 118, respectively, and direct the flow of fuel or oxygen as part of the catalytic process. A seal groove 126 is provided on one face of the plate 116. The seal groove preferably has an inwardly tapered cross section defined by inwardly slanting side surfaces connected by a generally planar bottom surface.

A compression strip 127 (see FIG. 7) is provided on the opposing face of plate 118 and corresponds to the shape of the seal groove 126 of the plate 116. The compression strip 127 aligns with the seal groove 126 when the fuel cell is assembled.

Multiple openings 130 extend through the plates and, when multiple fuel cells are stacked, define passages for fuel, oxygen, compression rods, waste products, etc. The compression strip 127 preferably circumscribes the openings 130.

The membrane/gasket assembly 120 comprises a proton exchange membrane 136 sandwiched between two GDL layers 138. As with the other embodiments, the proton exchange membrane 136 and the GDL layers 138 may be separate pieces or formed together as a composite or laminate and are collectively referred to as the membrane.

The membrane/gasket assembly 120 further includes a gasket 140 that is shaped to be received within the seal groove 126. The gasket 140 preferably has multiple lobes 141 arranged in sets on opposite surfaces of the gasket 140. Protuberances 142 are formed on the gasket sidewalls, which connect the upper surfaces of the gasket 140. The gasket defines portals 144 that correspond to and circumscribe the openings 130 on the plates. The gasket 140 also defines a membrane working area 146 that overlies a substantial portion of the grooves 122.

As is best seen in FIG. 7, in the undeformed state, the gasket 140 is sized so that the protuberances 142 of the sidewalls are adjacent to or just abut the sidewalls of the plate 116. The protuberances 142 are sized and pressed within the groove 122 to retain the gasket therein through compressive forces, frictional forces, or both. The lobes 141 contact the bottom of the groove 126. In the uncompressed state, the gasket 140 leaves substantial portions of the groove 126 unfilled.

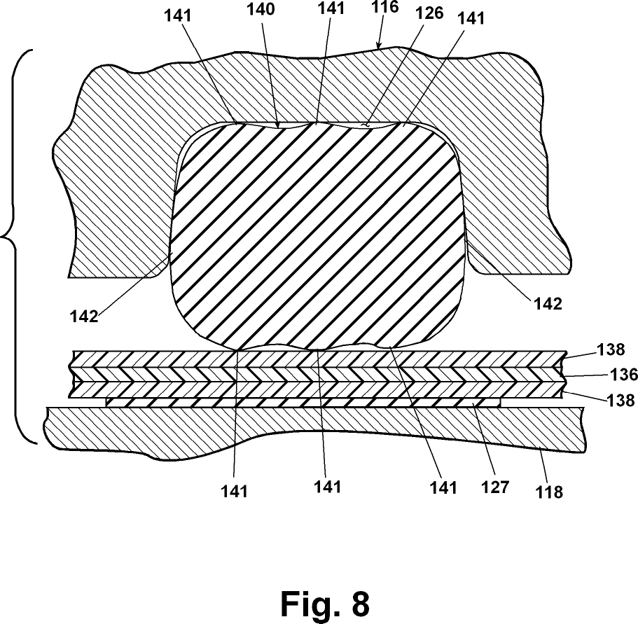

As best seen in FIG. 8, when the fuel cell 112 is assembled, the gasket 140 deforms to substantially fill the seal groove 126. However, the lobes 141 still provide discreet seals at their respective interfaces with the bottom surface of the groove 126 to thereby define multiple seal lines between the gasket and the bottom surface of the groove 126. In the compressed state, the protruding sidewalls 142 are compressed and abut the groove side surfaces for substantially the entire depth of the groove 126.

In addition to the gasket 140 forming a seal with respect to the plate 116, the gasket 140 also seals the membrane with respect to the plate 118. In the compressed state, the lobes 141 contacting the membrane are deformed to expand the contact area between the lobes and the membrane, forming discreet seals at each of the contact points. Additionally, the membrane is pressed into the compression strip 127 to enhance the seal between the gasket 140 and the plate 118.

For the second embodiment, it should be noted that the compression strip 127 is preferred, but is optional. The gasket 140 can typically apply a sufficient force to the membrane to seal it with respect to the plate 118. However, the elastomer layer 127 enhances the seal between the gasket 140 and the plate 118.

It should also be noted that as illustrated in FIGS. 6-8, the membrane is separate from the gasket 140. However, it is within the scope of the invention for the gasket 140 to be integrally connected or formed with the membrane. If the gasket 140 is thus associated with the membrane, it is preferred that the lobes 141 are not provided on any surface of the gasket 140 contacting the membrane.

It should further be noted that FIGS. 7 and 8 exaggerate the gap between the plates 116 and 118 and the GDL 138 and PEM 136 layers (also know as the soft goods) for clarity sake. In the actual assembly, the soft goods will contact the plates 116 and 118. The compression force applied to the fuel cell stack is partially resisted by the continuous contact between the plates and the soft goods. It is within the scope of the invention for the GDL not to extend under the gasket. For that matter, none of the soft goods have to extend under the gasket as illustrated. The soft goods can terminate prior to reaching the gasket, improving the overall contact between the soft goods and the plates.

A benefit of the second embodiment is that the gasket 140 is uniquely shaped so that it can easily be received within the seal groove 126 while still providing multiple seal lines with respect to the gasket and the channel 126 in the compressed state. The multiple seal lines are formed by the side protuberances 142 and the lobes 141 with the groove and interfaces of plates. The seal between the gasket 140 and the seal groove 126 is enhanced by the seal groove 126 having a tapered cross section. Although illustrated with three lobes 141, it is within the scope of the invention for there to be as few as two lobes.

The shape of the gasket 140 in relation to the shape of the groove 126 is very important in obtaining the required performance from the gasket 126. The collective gaskets 126 in a fuel cell stack must be resist the stack compression forces a sufficient amount to prevent the anode and cathode plates from contacting each other, which would electrically short the fuel cell stack. The contact between the GDL or soft goods and the plates combines with the compressive resistance of the gaskets to keep the plates from contacting.

Lateral leaking is controlled by the interaction between the gasket and the groove. The lobes 141 of the gasket and the protuberances 142 deform when compressed in such a manner to substantially fill the groove 126. Each of the lobes 141 and protuberances 142 effectively form a seal line that resists the lateral movement of the hydrogen or air from the working area 146. The angle of the surfaces of the lobes and protrusions are selected to control the compressed shape of the gasket to ensure its contact with the plate and filling of the groove. The tapered sidewalls of the groove 126 aid in the gasket being snuggly received within the groove. The taper is preferably controlled along with the cross-sectional shape of the gasket so that the gasket tends to fill in the groove when compressed.

The gasket 142 and groove 126 must be shaped to resist the compressive force of approximately 25 psig. The gasket 142 and groove must be able to resist internal pressures up to approximately 30 psig.

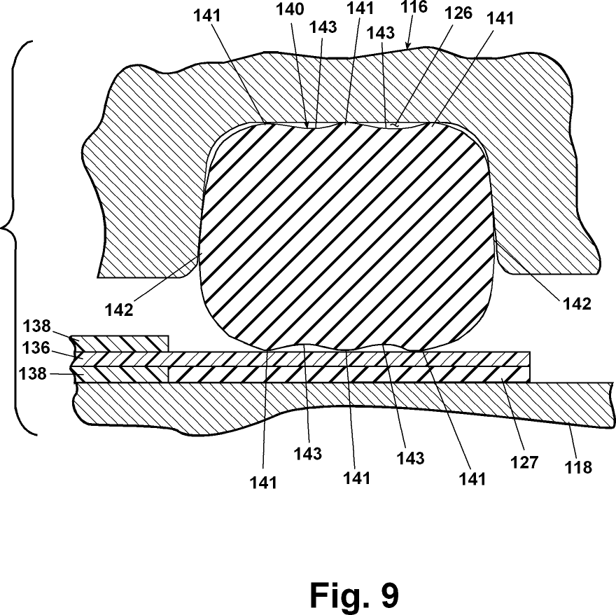

FIG. 9 illustrates a first alternative construction of the second embodiment fuel cell illustrated in FIGS. 6-8. The first alternative construction is identical to the second embodiment except that the GDL layers 138 doe not extend beneath the gasket 140. Since the GDL layers 138 function to disperse the gas over the working area 146, the edges of the GDL will not need to be sealed if they are sealed by or do not extend beyond the gasket 140. Therefore, the first alternative construction reduces the assembly complexity of the fuel cell.

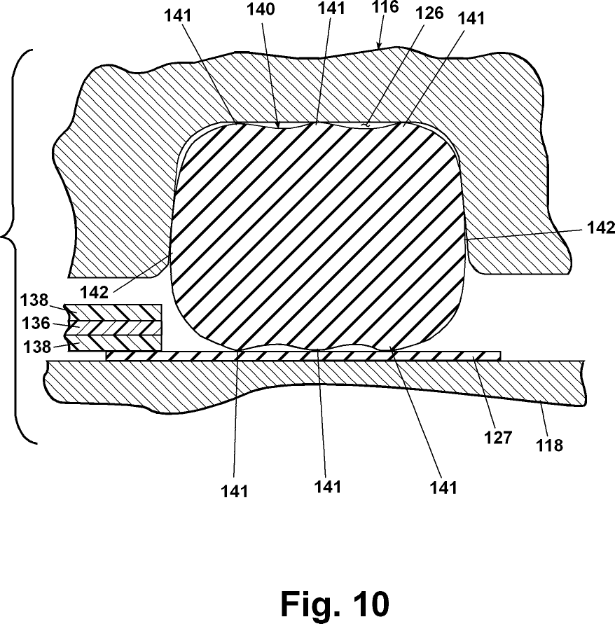

FIG. 10 illustrates a second alternative construction of the second embodiment fuel cell, which is similar to the second embodiment except that neither the GDL layers 138 or the PEM 136 extend beneath the gasket 140. The second alternative construction reduces the likelihood that the PEM can interfere with the seal between the gasket 140 and the seal strip 127, while increasing the difficulty of positioning and holding the PEM 136 in the desired location during assembly. That is, the gasket 140, when overlying the PEM serves to hold the PEM in place during the assembly of the multiple fuel cells. Without the gasket holding the PEM in place, the PEM is more susceptible to movement during assembly. However, once assembled, the compression forces acting on the PEM from the plates 116 and 118 are sufficient to hold the PEM in the assembled position.

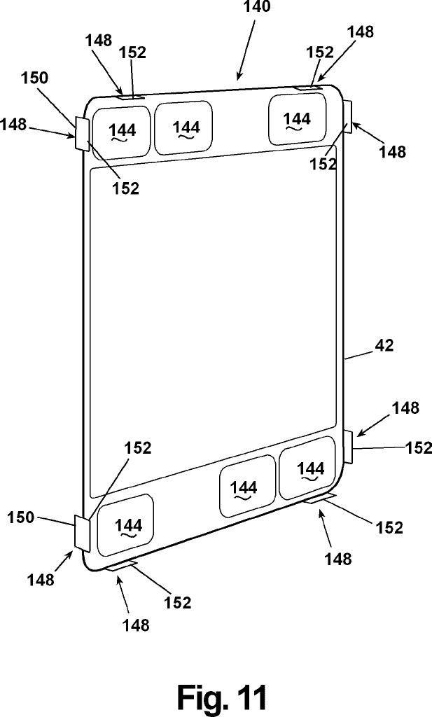

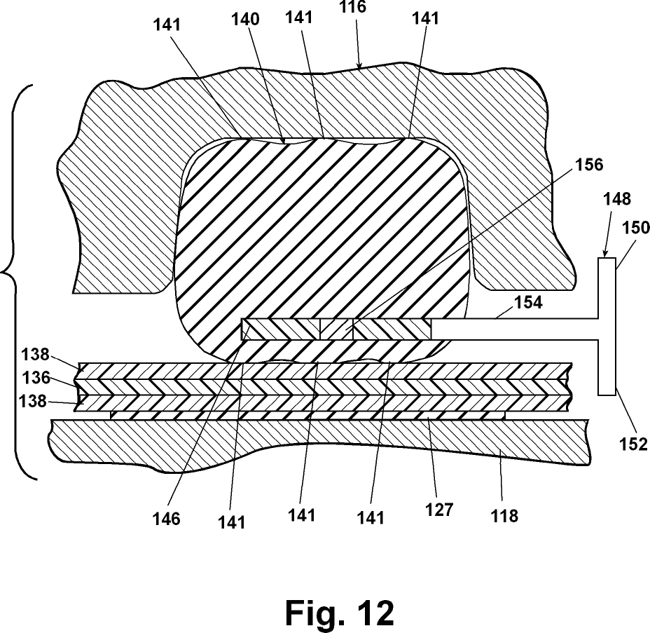

FIGS. 11 and 12 illustrate an alternative construction of the second embodiment fuel cell. The alternative construction is substantially identical to the membrane/gasket assembly 120 as shown in FIGS. 6-8, except that a backbone 146 is formed within the gasket 140 to provide the gasket with structural rigidity. The backbone preferably includes multiple positioning tabs 148 comprising opposing elements 150, 152, supported by a spacer 154 integrally formed with the backbone 146. The positioning tabs 148 are preferably located at the corners of the gasket 140 to help aid in the alignment of the gasket 140 with respect to the plates 116 and 118. The backbone 146 additionally includes multiple openings 156 through which the gasket material can flow during the forming of the gasket to mechanically lock the gasket 140 to the backbone 146. The backbone 146 can be placed anywhere within the interior of the gasket 140. The backbone 146 is preferably placed in a position to permit the positioning tabs 172 to extend outwardly between the plates 116 and 118.

In addition to being made from a separate element, the backbone 146 can be made from a dual durometer material. For example, the gasket can be made from a hard rubber center and a softer exterior. The hard rubber center forms the backbone.

The backbone improves the handling characteristics of the gasket, which is otherwise pliable and substantially bends under its own weight. The rigidity imparted by the backbone to the gasket is sufficient for the gasket to be automatically assembled.

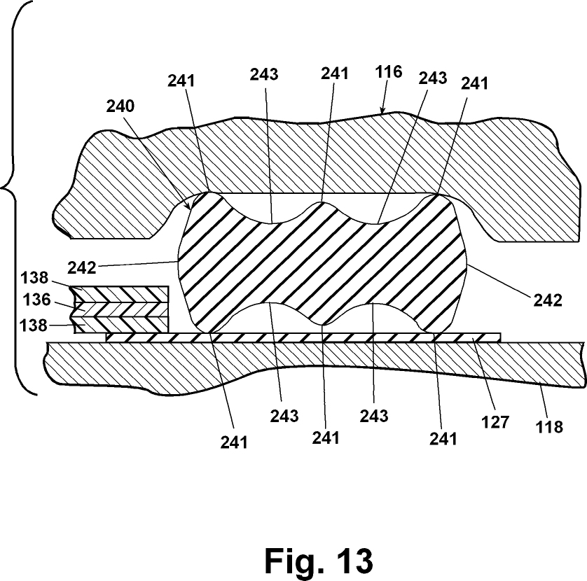

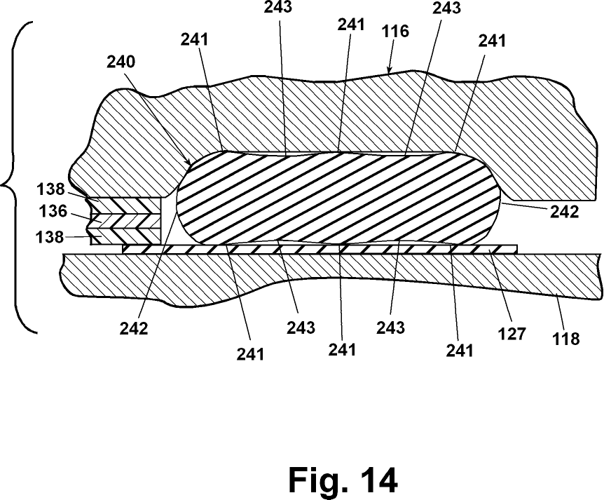

FIGS. 13 and 14 illustrate an alternative gasket 240 whose cross section is illustrated in the context of the second embodiment fuel cell but which can be used with either the first or second embodiment. The alternative gasket includes three lobes 241, preferably on opposing sides of the gasket 241 as does the gasket 140. The lobes 241 form seal lines relative to the groove 126 of the plate 116 and the seal strip 127 or with the other plate 118 if the seal strip is not used.

The lobes can be regularly or irregularly spaced relative to each other. It is preferred that when the gasket 240 is uncompressed, the middle lobe 241 is shorter than the other two outer lobes 241. In this manner, the plates 116, 118 of the fuel cell can be compressed to a greater degree or placed under a greater compressive force, in other words, without the gasket 240 becoming solid when its ability to compress is exceeded. In other words, the alternative gasket 240 has a reduced cross-sectional area for the volume it fills in the groove 126 in the uncompressed state. The reduced cross-sectional area permits the plates 116, 118 to be compressed with a greater force and positioned closer to each other than in the second embodiment without the gasket becoming solid, which permits the gasket 240 to maintain its discrete seals relative to one of both of the plates 116, 118 or seal strip 127.

Channels 243 separate the lobes 241 so that the lobes have a generally concave shape and the channel 243 has a generally convex shape and connects adjacent loves. The channels 243 and loves 241 preferably have an arcuate cross section.

As with the gasket 140, the gasket 240 has protuberances 242 extending outwardly from the sides of the gasket 100 when the gasket 100 is uncompressed. The protuberances can be sized such that they retain the gasket within the groove during assembly by compressive and/or compressive forces. The protuberances 242 also laterally expand to seal against side walls of the groove 126.

Preferably, each lobe 241 has a radius of curvature between approximately 0.005 in. to 0.010 in., such as approximately 0.08 in., for example. The channels 243 preferably have a radius of curvature between approximately 0.20 in. to 0.25 in., such as approximately 0.23 in., for example. The protuberances 242 preferably have a radius of curvature between approximately 0.02 in. to 0.04 in., such as approximately 0.03 in., for example. The uncompressed thickness of the gasket 240 is preferably between approximately 0.03 in. to 0.10 in., such as approximately 0.06 in., for example.

While the invention has been specifically described in connection with certain specific embodiments thereof, it is to be understood that this is by way of illustration and not of limitation, and the scope of the appended claims should be construed as broadly as the prior art will permit.

Claims

An assembly comprising:
a first fuel cell plate;
a second fuel cell plate; and
a gasket adapted to form a seal between the first and second fuel cell plates, the gasket including a first set of at least two spaced lobes to contact the first fuel cell plate when the gasket is compressed between the first and second fuel cell plates.

The assembly of claim 1, wherein one of said at least two spaced lobes contacts the first fuel cell plate when the gasket is uncompressed and another one of said at least two spaced lobes does not contact the first fuel cell plate when the gasket is uncompressed.

The assembly of claim 2, wherein the gasket further comprises:
channels between said at least two spaced lobes and substantially parallel to said at least two spaced lobes.

The assembly of claim 3, wherein at least one of the channels has a generally curved cross section.

The assembly of claim 4, wherein the channel cross section comprises an arcuate cross section.

The assembly of claim 5, wherein the radius of the curvature of the channel cross-section is approximately between 0.020 inches and 0.025 inches.

The assembly of claim 6, wherein the radius of curvature of the channel cross section is approximately 0.023 inches.

The assembly of claim 6, wherein at least one of the lobes has a radius of curvature of approximately 0.005 inches to 0.010 inches.

The assembly of claim 8, wherein the radius of curvature is 0.008 inches.

The assembly of claim 8, wherein the gasket includes at least one protuberance adapted to expand between the first and second plates when compressed

The assembly of claim 10, wherein the protuberance has a radius of curvature approximately between 0.02 inches and 0.04 inches.

The assembly of claim 11, wherein the protuberance has a radius of curvature of approximately 0.03 inches.

The assembly of claim 11, and further comprising a second set of at least two spaced lobes to contact the second fuel cell plate when the gasket is compressed between the first and second fuel cell plates.

The assembly of claim 13, wherein the second set of at least two spaced lobes are a mirror image of the first set of at least two spaced lobes.

The assembly of claim 14, wherein the maximum height of the gasket in the uncompressed state is approximately between 0.057 inches and 0.062 inches.

The assembly of claim 15, wherein the maximum height of the gasket in the uncompressed state is approximately 0.0595 inches.

The assembly of claim 15, wherein one of the plates comprises a gasket groove sized to receive the gasket.

The assembly of claim 17, wherein the gasket groove is approximately 0.018 inches to 0.022 inches deep.

The assembly of claim 18, wherein the gasket groove has a maximum width of approximately 0.120 inches to 0.140 inches.

The assembly of claim 19, wherein the gasket cross section has a maximum width of approximately 0.115 inches to 0.135 inches.

The assembly of claim 20, wherein the plates have a maximum thickness of approximately 0.060 inches to 0.120 inches.

The assembly of claim 1, wherein a gasket groove is formed in one of the first and second plates and the gasket at least partially resides in the gasket groove.

The assembly of claim 1, wherein a radius of curvature of at least one of the lobes is approximately between 0.005 inches and .010 inches.

The assembly of claim 1, wherein the gasket includes at least one protuberance adapted to expand between the first and second plates when compressed.

The assembly of claim 24, wherein the protuberance has a radius of curvature approximately between 0.02 inches and 0.04 inches.

The assembly of claim 1, and further comprising a second set of at least two spaced lobes to contact the second fuel cell plate when the gasket is compressed between the first and second fuel cell plates.

The assembly of claim 26, wherein the second set of at least two spaced lobes are a mirror image of the first set of at least two spaced lobes.

An assembly comprising:
a first fuel cell plate;
a second fuel cell plate; and
a gasket adapted to form a seal between the first and second fuel cell plates, the gasket including a first set of at least three spaced lobes to contact the first fuel cell plate when the gasket is compressed between the first and second fuel cell plates.

The assembly of claim 28, wherein two of said at least three spaced lobes contact the first fuel cell plate when the gasket is uncompressed and another one of said at least three spaced lobes does not contact the first fuel cell plate when the gasket is uncompressed.

The assembly of claim 29, wherein said another one of said at least three spaced lobes is located between said two of said at least three spaced lobes.

The assembly of claim 30, wherein at least one of the lobes has a radius of curvature of approximately 0.005 inches to 0.010 inches.

The assembly of claim 31, wherein the radius of curvature is 0.008 inches.

The assembly of claim 30, wherein the gasket further comprises:
channels between said at least three spaced lobes and substantially parallel to said at least three spaced lobes.

The assembly of claim 33, wherein at least one of the channels has a radius of curvature of approximately between 0.020 inches and 0.025 inches.

The assembly of claim 33, wherein a gasket groove is formed in one of the first and second plates and the gasket at least partially resides in the gasket groove.

The assembly of claim 35, wherein the gasket groove is approximately 0.018 inches to 0.022 inches deep.

The assembly of claim 36, wherein the gasket groove has a maximum width of approximately 0.120 inches to 0.140 inches.

The assembly of claim 37, wherein the gasket includes at least one protuberance to expand between the first and second plates when compressed.

The assembly of claim 28, wherein a radius of curvature of at least one of the lobes is approximately between 0.005 inches and .010 inches.

The assembly of claim 28, wherein the gasket includes at least one protuberance to expand between the first and second plates when compressed.

The assembly of claim 40, wherein the protuberance has a radius of curvature approximately between 0.02 inches and 0.04 inches.

The assembly of claim 28, wherein the gasket further includes a second set of at least three additional spaced lobes to contact the second fuel cell plate when the gasket is compressed between the first and second fuel cell plates.

The assembly of claim 42, wherein two of said at least three additional spaced lobes contact the second fuel cell plate when the gasket is uncompressed and another one of said at least three additional spaced lobes does not contact the second fuel cell plate when the gasket is uncompressed.

The assembly of claim 43, wherein said another one of said at least three additional spaced lobes is located between said two of said at least three additional spaced lobes.

The assembly of claim 22, wherein the gasket further comprises:
channels located between said at least three additional spaced lobes and parallel to said at least three additional spaced lobes.

A method usable with a first fuel cell plate and a second fuel cell plate, comprising:
providing a gasket having at least three spaced lobes between the first and second fuel cell plates; and
compressing the gasket between the first and second fuel cell plates to cause the at least three spaced lobes of the gasket to contact the first fuel cell plate thereby forming a seal

The method of claim 46, wherein two of the at least three lobes of the gasket extend to an imaginary plane and one of the at least three lobes does not extend to the imaginary plane so that prior to the compressing step, the two of the at least three lobes extending to the imaginary plane contact the first fuel cell plate and the one of the at least three lobes does not.

The method of claim 47, wherein all of the at least three lobes are contact the first fuel cell plate during the compressing step.

The method of claim 47, wherein the one of said at least three spaced lobes is located between the two of said at least three spaced lobes.

The method of claim 46, further comprising:
establishing channels between said at least three spaced lobes, the channels being substantially parallel to said at least three spaced lobes.

The method of claim 46, wherein the compressing further causes at least three additional spaced lobes of the gasket to contact the second fuel cell plate.
